(19) United States
(12) Patent Application Publication
(10) Pub. No.: US 2019/0013153 A1
(43) Pub. Date: Jan. 10, 2019

(54) ELECTROLYTIC CAPACITOR

(71) Applicant: Panasonic Intellectual Property Management Co., Ltd., Osaka (JP)

(72) Inventors: YUKARI SHIMAMOTO, Kyoto (JP); HIROSHI YOSHIDA, Kyoto (JP); KYOHEI KOBAYASHI, Hyogo (JP)

(21) Appl. No.: 16/128,670

(22) Filed: Sep. 12, 2018

Related U.S. Application Data
(63) Continuation of application No. PCT/JP2017/001890, filed on Jan. 20, 2017.

(30) Foreign Application Priority Data
Mar. 25, 2016 (JP) 2016-062581

(51) Int. Cl. H01G 9/048; H01G 9/012; H01G 9/07; H01G 9/025; H01G 9/26; H01G 9/10

(52) U.S. Cl. CPC H01G 9/048; H01G 9/012; H01G 9/07; H01G 9/0032; H01G 9/26; H01G 9/10; H01G 9/025

(57) ABSTRACT

An electrolytic capacitor includes a capacitor element group including a plurality of capacitor elements stacked on each other. Each of the plurality of capacitor elements includes an anode body. The anode body includes a first region close to a first side edge and a second region close to a second side edge. A solid electrolyte layer is disposed on a surface of a dielectric layer which is positioned in the first region. The second region includes a narrowed part and a junction part. The narrowed part has a length shortened in a direction along the second side edge. A shortest distance W1 between a central line and a side edge of a cutout, which forms the narrowed part, is shorter than a shortest distance W2 between the junction part and the central line. The central line is extending in a direction orthogonal to both of the direction along the second side edge and a thickness direction of the anode body and equally dividing the anode body.

### RELATED APPLICATIONS

This application is a continuation of the PCT International Application No. PCT/JP2017/001890 filed on Jan. 20, 2017, which claims the benefit of foreign priority of Japanese patent application No. 2016-062581 filed on Mar. 25, 2016, the contents all of which are incorporated herein by reference.

### BACKGROUND

### 1. Technical Field

The present disclosure relates to an electrolytic capacitor, and particularly to an electrolytic capacitor including a plurality of stacked capacitor elements.

### 2. Description of the Related Art

The capacitance of an electrolytic capacitor has been required to be increased along with increase of functionalities of electronic devices. For example, Unexamined Japanese Patent Publication No. 2004-319795 discloses an electrolytic capacitor including a capacitor element group including a plurality of sheet capacitor elements stacked on each other.

Each of the capacitor elements includes a dielectric layer formed on a surface of a sheet anode body, a solid electrolyte layer formed on a surface of the dielectric layer, and a cathode lead-out layer formed on a surface of the solid electrolyte layer. The dielectric layer is formed on all or part of a surface of the anode body. The solid electrolyte layer and the cathode lead-out layer are formed to cover a part of the surface of the dielectric layer. A part of the anode body, the dielectric layer, the solid electrolyte layer, and the cathode lead-out layer serve as a cathode part of the capacitor element. The rest of the anode body (and the dielectric layer), on which the solid electrolyte layer and the cathode lead-out layer are not formed, serves as an anode part. The anode parts of the capacitor elements included in the capacitor element group are joined, and electrically connected with each other.

### SUMMARY

An electrolytic capacitor according to the present disclosure includes a capacitor element group including a plurality of capacitor elements stacked on each other, an anode terminal electrically connected with an anode body, and an outer package body covering the capacitor element group so as to expose a part of the anode terminal. The plurality of capacitor elements each include an anode body, a dielectric layer on the anode body, a solid electrolyte layer on the dielectric layer, and a cathode lead-out layer on the solid electrolyte layer. The anode body has a sheet shape and includes a first side edge and a second side edge opposite to the first side edge. The anode body includes a first region close to the first side edge, a second region close to the second side edge, and a boundary between the first region and the second region. The solid electrolyte layer is disposed on the surface of the dielectric layer which is positioned in the first region. The second region includes a narrowed part and a junction part. The narrowed part has a length shortened in a direction along the second side edge. The junction part is for joining the capacitor element to another capacitor element adjacent to the capacitor element in the capacitor element group. The junction part is disposed between the narrowed part and the second side edge. A shortest distance W1 between a central line and a side edge of a cutout is shorter than a shortest distance W2 between the junction part and the central line. The central line extends in a direction orthogonal to both of the direction along the second side edge and a thickness direction of the anode body and equally dividing the anode body. The cutout forms the narrowed part.

In the electrolytic capacitor according to the present disclosure, stress applied on a boundary between an anode part and a cathode part can be reduced. As a result, reliability is improved.

### BRIEF DESCRIPTION OF THE DRAWINGS

FIG. 1 is a cross-sectional view schematically illustrating an electrolytic capacitor according to an exemplary embodiment of the present disclosure;

FIG. 2 is a cross-sectional view schematically illustrating a capacitor element according to the exemplary embodiment of the present disclosure;

FIG. 3 is a top view schematically illustrating an anode body according to the exemplary embodiment of the present disclosure; and

FIG. 4 is an enlarged top view illustrating a main part of the anode body illustrated in FIG. 3.

### DETAILED DESCRIPTION OF EMBODIMENT

Problems with the conventional technique will be briefly described before description of an exemplary embodiment of the present disclosure.

Since a cathode part includes a solid electrolyte layer and a cathode lead-out layer, the cathode part is thicker than an anode part. Thus, when a plurality of capacitor elements are stacked and the anode parts of the capacitor elements are joined with each other, stress is applied on each capacitor element at a boundary between the anode part and the cathode part. Accordingly, leakage current of an electrolytic capacitor that has such a configuration increases in some cases. In addition, the stacked capacitor elements are shifted from each other in some cases. Such failure is more significant when a length (length in a direction orthogonal to the boundary between the anode part and the cathode part) of the anode part is short.

The present disclosure is intended to solve the above-described problems and to provide an electrolytic capacitor that can reduce stress applied on a boundary between an anode part and a cathode part.

An electrolytic capacitor includes a capacitor element group including a plurality of capacitor elements stacked on each other, an anode terminal, and an outer package body covering the capacitor element group. Each of the plurality of capacitor elements includes a sheet anode body, a dielectric layer formed on a surface of the anode body, a solid electrolyte layer formed on a surface of the dielectric layer, and a cathode lead-out layer formed on a surface of the solid electrolyte layer. The anode body includes a first region close to a first side edge, a second region close to a second side edge opposite to the first side edge, and a boundary between the first region and the second region. The dielectric layer is formed on a surface of the first region.

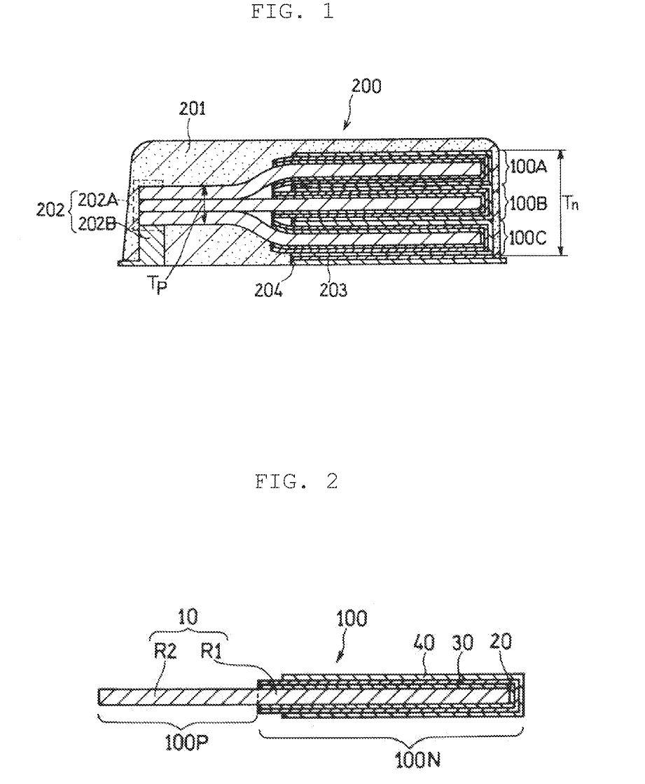

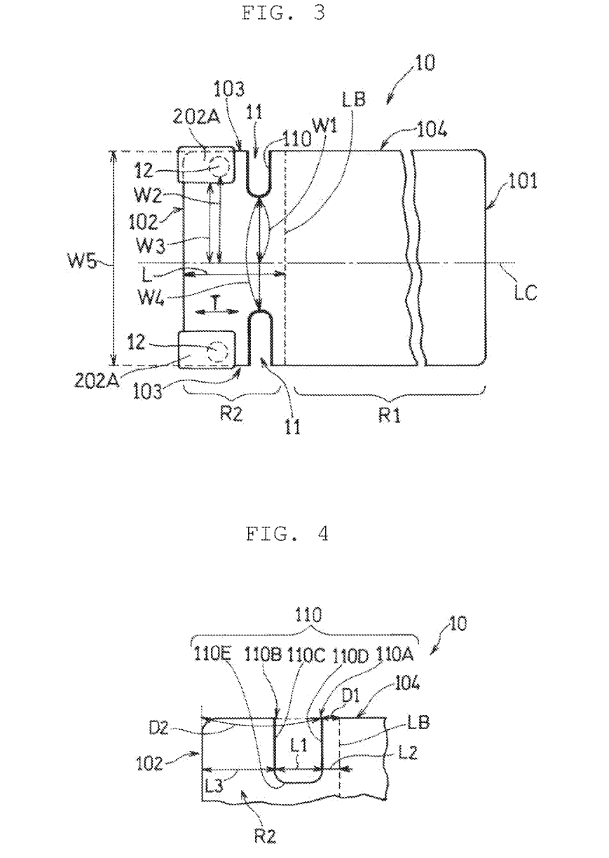

Configurations of an electrolytic capacitor, a capacitor element, and an anode body according to the present exemplary embodiment will be described below in detail with reference to the accompanying drawings. FIG. 1 is a cross-sectional view schematically illustrating electrolytic capacitor 200 according to the present exemplary embodiment. FIG. 2 is a cross-sectional view schematically illustrating capacitor element 100 according to the present exemplary embodiment. FIG. 3 is a top view schematically illustrating anode body 10. FIG. 4 is an enlarged top view illustrating a main part of anode body 10 illustrated in FIG. 3.

### (Electrolytic Capacitor)

For example, as illustrated in FIG. 1, electrolytic capacitor 200 includes a capacitor element group formed by stacking a plurality of capacitor elements 100. Electrolytic capacitor 200 illustrated in FIG. 1 includes a capacitor element group including the plurality of stacked capacitor elements 100 (100A to 100C) and sealed by outer package body 201. Anode terminal 202 is electrically connected with second region R2 (refer to FIG. 2) of at least one of capacitor elements 100. Cathode terminal 203 is electrically connected with cathode lead-out layer 40 (refer to FIG. 2) of at least one of capacitor elements 100.

For example, the plurality of stacked capacitor elements 100 are joined with each other by laser welding, resistance welding, needle swaging, brazing and soldering, or the like at a predetermined position in second region R2 of each capacitor element 100, and are electrically connected with each other. Specifically, junction part 12 (refer to FIG. 3) for joining adjacent capacitor elements 100 is formed in second region R2 of each capacitor element 100. Adjacent capacitor elements 100 may be joined with each other through another conductive member (for example, a metal plate or a metal piece). Although the capacitor element group illustrated in FIG. 1 includes three capacitor elements 100, the number of capacitor elements 100 is not limited.

### (Capacitor Element)

For example, as illustrated in FIG. 2, capacitor element 100 includes sheet anode body 10, dielectric layer 20 formed on at least part of a surface of anode body 10, solid electrolyte layer 30 formed on at least part of a surface of dielectric layer 20, and cathode lead-out layer 40 formed on at least part of a surface of solid electrolyte layer 30. Capacitor element 100 has a sheet shape.

Anode body 10 includes first region R1 and second region R2. Dielectric layer 20 is formed at least on a surface of first region R1. First region R1, dielectric layer 20, solid electrolyte layer 30, and cathode lead-out layer 40 serve as cathode part 100N of capacitor element 100. Second region R2 serves as anode part 100P of capacitor element 100. Thus, boundary LB between first region R1 and second region R2 is a boundary between anode part 100P and cathode part 100N of capacitor element 100. In other words, boundary LB is a boundary of division based on whether solid electrolyte layer 30 is provided. A region in which solid electrolyte layer 30 is formed in anode body 10 is first region R1, and the other region is second region R2. FIGS. 3 and 4 each illustrate boundary LB with a dashed line.

### (Anode Body)

Anode body 10 is a sheet containing valve metal as conductive material. Examples of the valve metal include titanium, tantalum, aluminum, and niobium. Anode body 10 may contain one, or two or more of the above-described valve metals. Anode body 10 may contain valve metals as alloy or intermetallic compound. Anode body 10 is not limited to a particular thickness, but may have a thickness ranging from 15 μm to 300 μm, inclusive, for example.

First region R1 of anode body 10 is disposed at a side closer to first side edge 101. A surface of first region R1 is preferably etched. The etching increases capacitance. Second region R2 is disposed at a side closer to second side edge 102 opposite to first side edge 101. Second region R2 may or may not be etched.

Since cathode part 100N includes solid electrolyte layer 30 and cathode lead-out layer 40, cathode part 100N is thicker than anode part 100P. Thus, when the plurality of capacitor elements 100 are stacked and joined with each other at a predetermined position in second region R2, capacitor elements 100 are typically bent at boundary LB and between boundary LB and second side edge. Accordingly, stress is likely to be applied near boundary LB of anode body 10. When distance L (refer to FIG. 3) between boundary LB and second side edge 102 is sufficiently long, the stress is small. However, sufficiently long distance L leads to decrease of capacitance density, and thus is not preferable.

In the present exemplary embodiment, second region R2 includes narrowed part 11 having a length shortened in a direction along second side edge 102 (direction parallel to second side edge 102). When second regions R2 of the plurality of capacitor elements 100 are joined with each other, a region between narrowed part 11 and second side edge 102 is easily bent in a thickness direction of the capacitor element group. The bending is conducted along a line extending from an end part of narrowed part 11 (near connection part 110E, described later) in direction T different from the direction along second side edge 102. Direction T is, for example, a direction (refer to FIG. 3) orthogonal to both of the direction along second side edge 102 and the thickness direction of anode body 10.

Accordingly, thickness difference Td between thickness Tn (refer to FIG. 1) of a region corresponding to first region R1 and thickness Tp of a region corresponding to second region R2 in the capacitor element group is absorbed by bending in the thickness direction of the capacitor element group at a plurality of places on a line extending in the direction along second side edge 102 in a region between boundary LB and narrowed part 11 and a line extending in direction T in the region between narrowed part 11 and second side edge 102. Thus, the stress applied on boundary LB is reduced. In particular, when distance L is 0.4 times to 3.0 times inclusive, more specifically, 0.8 times to 2.0 times inclusive, longer than thickness difference Td, the stress is largely reduced.

Thickness Tn is, for example, an average value of thicknesses at optional five points in a stacking direction in the region corresponding to first region R1 in the capacitor element group. The optional five points corresponding to first region R1 are preferably positioned on central line LC extending in a direction orthogonal to second side edge 102 and equally dividing anode body 10, and selected except for points near boundary LB. Thickness Tp is a length connecting centers of junction parts 12 of two outermost capacitor elements 100 (in FIG. 1, capacitor elements 100A and 100C). The stacking direction is, for example, a direction normal to the surface of first region R1.

Narrowed part 11 is formed by cutting out part of second region R2 along the direction parallel to second side edge 102. Side edge 110 of a cutout forming narrowed part. 11 is entirely disposed in second region R2.

A relation between a degree of narrowing at narrowed part 11 and a position of junction part 12 is important to reduce the above-described stress. Specifically, the stress is reduced when narrowed part 11 is narrowed closer to central line LC as a reference than junction part 12. More specifically, narrowed part 11 is provided in such a shape that shortest distance W1 between central line LC and side edge 110 of the cutout is shorter than shortest distance W2 between junction part 12 and central line LC. In particular, when distance L is short (for example, distance L<shortest distance W1), the above-described stress is more likely to be reduced as shortest distance W1 is shorter.

In FIG. 3, two narrowed parts 11 are provided at positions opposite to each other with respect to central line LC, but the present disclosure is not limited to this configuration. For example, one narrowed part 11 may be provided, or narrows parts 11 may be provided asymmetrically with respect to central line LC. In particular, narrowed parts 11 are preferably provided at two positions opposite to each other with respect to central line LC because the stress is likely to be reduced with this configuration.

Each narrowed part 11 is preferably disposed in a vicinity of boundary LB. Accordingly, the region between narrowed part 11 and second side edge 102 increases, and thickness difference Td becomes likely to be absorbed by bending along a line in direction T. Thus, stress applied near boundary LB is further reduced. For example, when one end part (first end part 110A; refer to FIG. 4) of side edge 110 of the cutout is connected with fourth side edge 104 intersecting first side edge 101, and another end part (second end part 110B) of side edge 110 of the cutout is connected with third side edge 103 intersecting second side edge 102, distance D1 between first end part 110A and boundary LB is preferably shorter than distance D2 between first end part 110A and second side edge 102. A ratio D1/D2 of distance D1 with respect to distance D2 preferably ranges from 0.01 to 1.25, inclusive. In particular, distance D1 is preferably shorter than distance D2. Specifically, the ratio D1/D2 is preferably equal to or larger than 0.01 and smaller than 1.0.

Distance D1 is a shortest distance between first end part 110A and boundary LB. Similarly, distance D2 is a shortest distance between first end part 110A and second side edge 102. When anode body 10 includes a round corner and a boundary between second side edge 102 and third side edge 103 is unclear, distance D2 is set to be a shortest distance between an extended line from second side edge 102 and first end part 110A as illustrated in FIG. 4.

A width of anode body 10 in the direction along second side edge 102 at narrowed part 11 is preferably as small as possible with respect to width W5 of second side edge 102. Accordingly, anode body 10 can be easily bent along a line in direction T. On the other hand, in order to maintain strength of anode body 10, the width of narrowed part 11 is preferably not excessively smaller than width W5 of second side edge 102. With these requirements taken into consideration, a ratio W4/W5 of shortest width W4 of anode body 10 in the direction along second side edge 102 at narrowed part 11 with respect to width W5 of second side edge 102 preferably ranges from 0.25 to 0.5, inclusive. When anode body 10 includes a round corner, width W5 is set to be a shortest distance between two extended lines of third side edges 103 as illustrated in FIG. 3.

The shape of narrowed part 11 is not particularly limited. In particular, side edge 110 of the cutout preferably includes, at a side closer to second side edge 102, first straight part 110C extending in the direction along second side edge 102 as illustrated in FIG. 4. Accordingly, the region between narrowed part 11 and second side edge 102 is increased, and thus junction part 12 can be more easily disposed. Moreover, in this case, the region between narrowed part 11 and second side edge 102 can be easily bent along a line extending in direction T. Accordingly, thickness difference Td is more likely to be absorbed.

Side edge 110 of the cutout preferably includes, at a side closer to boundary LB, second straight part 110D extending in the direction along second side edge 102. Accordingly, the region between narrowed part 11 and second side edge 102 is increased. Specifically, a preferable shape of side edge 110 of the cutout is, for example, a U shape including first straight part 110C and second straight part 110D which are along second side edge 102. Connection part 110E connecting first straight part 110C and second straight part 110D is not limited to a particular shape, but may be a straight shape or a curved shape.

A ratio L2/L1 of distance L2 between boundary LB and second straight part 110D with respect to distance L1 between first straight part 110C and second straight part 110D preferably ranges from 0.1 to 4.0, inclusive, more preferably ranges from 0.1 to 0.5, inclusive. When narrowed part 11 is disposed close to boundary LB, second region R2 can be bent at multiple stages (or gradually) because of second straight part 110D and sufficiently long distance L1. Thus, the above-described stress is reduced. Moreover, in this case, the extremely simple shape of side edge 110 of the cutout leads to excellent productivity. For example, when narrowed part 11 is formed by punching out anode body 10, a blade used in the punching only need to be have a simple shape, thereby accurately forming narrowed part 11.

When side edge 110 of the cutout has the U shape including first straight part 110C and second straight part 110D, a ratio L2/L3 of distance L2 between boundary LB and second straight part 110D with respect to distance L3 between first straight part 110C and second side edge 102 preferably ranges from 0.1 to 1.7, inclusive, more preferably ranges from 0.1 to 0.3, inclusive. Accordingly, a sufficient area for connection with anode terminal 202 can be obtained in a region between first straight part 110C and second end part 102.

Distance L1 is an average value of lengths of lines extending from optional three points at first straight part 110C to second straight part 110D in a direction orthogonal to first straight part 110C. Distances L, L2, and L3 are average values, too, and can be calculated similarly.

Anode terminal 202 is disposed at a position corresponding to junction part 12, in other words, between narrowed part 11 and second side edge 102. In particular, anode terminal 202 is preferably disposed near third side edge 103 intersecting second side edge 102. This is because bending is unlikely to occur in this region. As illustrated in FIG. 1, anode terminal 202 is at least one of anode lead 202B connecting capacitor element 100 with outside and swaging member 202A electrically connected with anode lead 202B. Swaging member 202A is used to swage the plurality of capacitor elements 100, for example.

A depth (length in a direction orthogonal to central line LC) of the cutout at narrowed part 11 is preferably greater than a length of anode terminal 202 in the direction orthogonal to central line LC. In other words, shortest distance W1 between side edge 110 of the cutout and central line LC is preferably shorter than shortest distance W3 between anode terminal 202 and central line LC. Accordingly, bending along a line extending in direction T is unlikely to occur in a region in which anode terminal 202 is disposed, and thus connection reliability is likely to be obtained.

### (Dielectric Layer)

Dielectric layer 20 is formed through oxidation of the surface of first region R1 by performing, for example, anodization processing. The anodization may be achieved by a well-known method. Dielectric layer 20 is not particularly limited, but may be any insulating layer functioning as dielectric. Dielectric layer 20 is formed at least on the surface of first region R1.

### (Solid Electrolyte Layer)

Solid electrolyte layer 30 is formed on at least part of the surface of dielectric layer 20. Solid electrolyte layer 30 contains, for example, manganese compound and conductive polymer. Examples of the conductive polymer include polypyrrole, polythiophene, polyaniline, and derivatives of polypyrrole, polythiophene, and polyaniline.

Solid electrolyte layer 30 containing the conductive polymer may be formed through, for example, chemical polymerization and/or electrolytic polymerization of material monomer on dielectric layer 20. Alternatively, solid electrolyte layer 30 may be formed by applying, to dielectric layer 20, liquid containing conductive polymer polymerized in advance.

### (Cathode Lead-Out Layer)

Cathode lead-out layer 40 is formed on at least part of the surface of solid electrolyte layer 30. Cathode lead-out layer 40 includes, for example, a carbon layer, and a metal (for example, silver) paste layer formed on a surface of the carbon layer (both not illustrated). Cathode lead-out layer 40 is formed by sequentially applying carbon paste and silver paste.

### (Anode Terminal)

Capacitor elements 100 are joined with each other in second region R2 as illustrated in FIG. 1 and also may be swaged by swaging member 202A. This improves reliability of connection between stacked capacitor elements 100. Swaging member 202A is electrically connected with anode lead 202B. In this case, anode terminal 202 includes swaging member 202A, and anode lead 202B electrically connected with swaging member 202A. Part of anode lead 202B is exposed out of outer package body 201. Swaging member 202A and anode lead 202B may be integrated with each other or may be separated from each other.

Swaging member 202A is joined with each of second regions R2 of two outermost capacitor elements (in FIG. 4, capacitor elements 100A and 100C). For example, a plurality of capacitor elements are joined with each other by laser welding, and then swaging member 202A is disposed to sandwich capacitor element group at a position corresponding to this welded part. Then, laser welding is further performed in this state to join swaging member 202A and capacitor element group with each other. Swaging member 202A may be fabricated, for example, by bending a flat plate member.

Anode lead 202B is electrically connected with second region R2 of each capacitor element 100 through swaging member 202A. Anode lead 202B and swaging member 202A may be integrated with each other. Materials of swaging member 202A and anode lead 202B are not particularly limited but may be any conductive materials.

### (Outer Package Body)

Outer package body 201 is formed of, for example, insulating resin. Examples of the insulating resin include epoxy resin, phenol resin, silicone resin, melamine resin, urea resin, alkyd resin, polyurethane, polyimide, polyamide-imide, and unsaturated polyester.

### (Cathode Terminal)

Cathode terminal 203 is electrically connected with cathode lead-out layer 40. A material of cathode terminal 203 is not particularly limited but may be any conductive material. Cathode terminal 203 is joined with cathode lead-out layer 40 through, for example, conductive adhesive agent 204 as described above.

The electrolytic capacitor according to the present disclosure has excellent reliability and thus is applicable to various usages.

What is claimed is:

1. An electrolytic capacitor comprising:
a capacitor element group including a plurality of capacitor elements stacked on each other, the plurality of capacitor elements each including an anode body, a dielectric layer on the anode body, a solid electrolyte layer on the dielectric layer, and a cathode lead-out layer on the solid electrolyte layer, the anode body having a sheet shape and including a first side edge and a second side edge opposite to the first side edge;
an anode terminal electrically connected with the anode body; and
an outer package body covering the capacitor element group so as to expose a part of the anode terminal, wherein:
the anode body includes a first region close to the first side edge, a second region close to the second side edge, and a boundary between the first region and the second region,
the solid electrolyte layer is disposed on a surface of the dielectric layer which is positioned in the first region,
the second region includes a narrowed part and a junction part, the narrowed part having a length shortened in a direction along the second side edge, the junction part being for joining the capacitor element to another capacitor element adjacent to the capacitor element in the capacitor element group,
the junction part is disposed between the narrowed part and the second side edge, and
a shortest distance W1 between a central line and a side edge of a cutout is shorter than a shortest distance W2 between the junction part and the central line, the central line extending in a direction orthogonal to both of the direction along the second side edge and a thickness direction of the anode body and equally dividing the anode body, the cutout forming the narrowed part.

2. The electrolytic capacitor according to claim 1, wherein a distance L between the boundary and the second side edge is 0.4 times to 3.0 times, inclusive, longer than a difference Td between a thickness of the capacitor element group in a stacking direction in the first region and a thickness of the capacitor element group in the stacking direction in the second region.

3. The electrolytic capacitor according to claim 1, wherein:
the anode terminal is connected with the second region, and
the shortest distance W1 is shorter than a shortest distance W3 between the anode terminal and the central line.

4. The electrolytic capacitor according to claim 1, wherein a ratio W4/W5 of a length W4 of the narrowed part in the direction along the second side edge with respect to a length W5 of the second side edge ranges from 0.25 to 0.5, inclusive.

5. The electrolytic capacitor according to claim 1, wherein the side edge of the cutout includes a first straight part at a side closer to the second side edge, the first straight part extending in the direction along the second side edge.
